(19) United States
(12) Patent Application Publication
(10) Pub. No.: US 2017/0147764 A1
(43) Pub. Date: May 25, 2017

(54) METHOD AND SYSTEM FOR PREDICTING CONSULTATION DURATION

(71) Applicant: HITACHI, LTD., Tokyo (JP)

(72) Inventors: Sarath P R, Bangalore (IN); Sunil MANDHAN, Bangalore (IN)

(73) Assignee: HITACHI, LTD., Tokyo (JP)

(21) Appl. No.: 15/352,934

(22) Filed: Nov. 16, 2016

(30) Foreign Application Priority Data
Nov. 20, 2015 (IN) 6270/CHE/2015

(51) Int. Cl. G06F 19/00; G06Q 10/10; G06N 5/02

(52) U.S. Cl. CPC G06F 19/327; G06N 5/022; G06Q 10/1095

(57) ABSTRACT

The present disclosure relates to a method and system for predicting the consultation duration for a user in a healthcare system. In an embodiment, the appointment scheduling system used in the healthcare connects with the prediction system through a communication network or directly for predicting the consultation time of a user. The prediction system receives at least one of user attributes, medical records and current symptoms of the users. The prediction system further determines the consultation preparation time and actual consultation time which is used by the prediction system for predicting the consultation duration for a user.

### TECHNICAL FIELD

The present subject matter is related in general to predicting consultation duration and more particularly, but not exclusively, to a method and system for predicting consultation duration for a user in a healthcare system.

### BACKGROUND

The healthcare industry in the present context has evolved due to the changes in healthcare technology. Present healthcare systems operate on need basis. Typically, scheduling an appointment in the healthcare system for medical services is done by the appointment scheduling systems. However, the present appointment scheduling systems do not indicate the approximate time required for consulting users. Such an appointment scheduling system is inappropriate in terms of effective time-efficiency and user satisfaction.

In the current scenario, a number of healthcare systems allow the users to schedule an appointment using portal of the healthcare system through Internet. However, these appointment scheduling systems are not efficient in terms of time since the scheduling systems currently use fixed time slots for consulting users.

Additionally, as the medical service providers do not know the exact medical condition of the user, it becomes difficult to predict the time taken for consulting each user. Therefore, a user who has fixed an appointment for a particular time may have to wait based on the time taken by the service provider for prior users. Hence, there is a need for a system which can acquire complete medical information of users and also provide a predicted time for consultation of each user.

### SUMMARY

Disclosed herein is the method and system for predicting consultation duration for a user in a healthcare system. Consultation duration for a user is predicted by a prediction module, connected with an appointment scheduling systems. The prediction module determines an approximate time needed by user for consulting medical condition.

In one embodiment, the present disclosure relates to a method for predicting consultation duration for a user in a healthcare system. The method comprises receiving, at least one of user attributes, medical records of the user, and current symptoms of the user by a prediction module. The method further determines a severity score based on the medical records of the user. The prediction module determines consultation preparation time based on the severity score and user attributes. Further, the prediction module determines actual consultation time based on at least one of the current symptoms of the user, pre-defined disease of the current symptoms, pre-defined consultation duration for the current symptoms and details of service provider. On determining the consultation preparation time and actual consultation time, the prediction module predicts the consultation duration for a user based on the consultation preparation time and the actual consultation time.

In another embodiment, the present disclosure relates to a prediction module for predicting consultation duration for a user in a healthcare system. The prediction module comprises a processor and a memory communicatively coupled to the processor, wherein the memory stores processor executable instructions, which, on execution, causes the prediction module to receive at least one of user attributes, medical records and current symptoms of the user. The processor causes the prediction module to determine a severity score based on the medical records of the user, determine the consultation preparation time based on the user attributes and the severity score, determine the actual consultation time based on the at least one of the current symptoms of the user, pre-defined disease of the current symptoms, pre-defined consultation duration for the current symptoms and details of service provider. Thereafter, the processor causes the prediction module to predict the consultation duration for the user based on the consultation preparation time and the actual consultation time.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 shows an exemplary environment for predicting consultation duration for a user in healthcare system in accordance with some embodiments of the present disclosure;

FIG. 2 shows a detailed block diagram illustrating a prediction system in accordance with some embodiments of the present disclosure;

FIG. 3a illustrates a flowchart showing a method for calculating severity score for a user in accordance with some embodiments of present disclosure;

FIG. 3b shows an exemplary representation of a medical record for identifying a severity score in accordance with some embodiments of present disclosure;

FIG. 4a shows a method for generating a training model used in determining consultation preparation time in accordance with some embodiments of present disclosure;

FIG. 4b shows a method for predicting the consultation preparation time for a user using the trained model in accordance with some embodiment;

FIG. 5a illustrates a flowchart showing a method for determining average consultation time of the service provider in accordance with some embodiment of the present disclosure;

FIG. 5b illustrates a flowchart showing a method for determining the consultation time for the current symptoms in accordance with some embodiments of the present disclosure;

FIG. 6 illustrates an exemplary flowchart showing the method for predicting the consultation duration for a user in accordance with some embodiments of present disclosure; and

FIG. 7 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

The present disclosure relates to a method for predicting consultation duration for a user in a healthcare system. The method comprises receiving at least one of user attributes, medical records and current symptoms from the user at the time of scheduling an appointment with the healthcare system. In an embodiment, the appointment can be scheduled by using the appointment scheduling interface like healthcare websites, mobile phones etc. In an embodiment, the user can input reference identity, using which the prediction module may extract user attributes and medical records of the user. On receiving the user attributes, medical records and current symptoms, the prediction module determines a severity score for the user based on the medical records. The appointment system at the time of scheduling an appointment consults the prediction module for predicting the consultation duration for a user. In an embodiment, the prediction module may be configured within the appointment system. The prediction module determines the user consultation preparation time based on the user attributes and the severity score. The prediction module further determines the actual consultation time based on at least one of the current symptoms of the user, pre-defined disease of the current symptoms and pre-defined consultation duration for the current symptoms. Further, the prediction module predicts the consultation duration for the user based on the consultation preparation time and the actual consultation time. Hence, in such a way the consultation duration for a user is predicted by the prediction module which improves the satisfaction of the user. Further a flexible time slots is provided by the prediction module, which in turn reduces the wait time for the users in the healthcare systems.

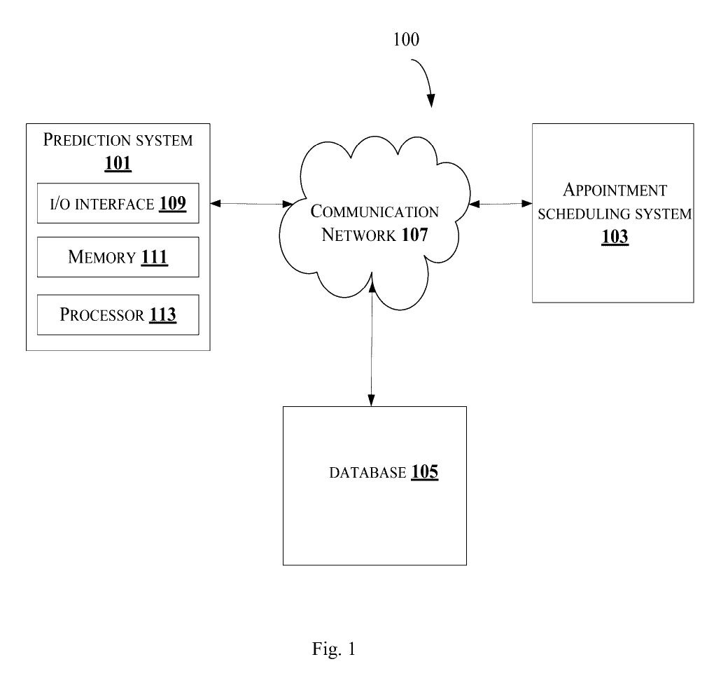

FIG. 1 shows an exemplary environment for predicting the consultation duration for a user in healthcare system in accordance with some embodiments of the present disclosure.

As shown in FIG. 1, the environment 100 comprises a prediction system 101 (also referred to as prediction module 101), an appointment scheduling system 103 and database 105 interconnected through a wired or/and wireless communication network 107. The database 105 contains medical records of users, service providers details, available time slots, scheduled time slots, pre-defined diseases for current symptoms, pre-defined consultation duration for current symptoms etc. The user defined herein is an entity which uses, or requests the medical services of the healthcare system, for example a patient. The service provider defined herein is an entity which provides medical services to users. In an embodiment the service provider includes doctors, physicians, technician operators which provide medical services to the user in the healthcare systems.

The prediction system 101 predicts the consultation duration for a user. The appointment scheduling system 103 is used in the healthcare system for scheduling an appointment at a particular time with the medical service provider. The appointment scheduling system 103 are used for providing timely access to healthcare. In an embodiment, the appointment scheduling system 103 connects with the prediction system 101 to predict the duration for consultation of a user at the time of scheduling an appointment. In an embodiment, the prediction system 101 is configured within appointment scheduling system 103 to predict the duration for consultation of a user at the time of scheduling an appointment. The prediction system 101 and the appointment scheduling system 103 communicate with the database system 105 either through a communication network 107 or directly for assessing the required information for predicting the consultation duration. In an embodiment, a user connects to a healthcare system either through healthcare web interface or mobile phones to fix an appointment with the healthcare system. In an embodiment, the consultation duration for the user is also displayed in the information display outside the consultation room.

The prediction system 101 comprises an I/O Interface 109, a memory 111 and a processor 113. The I/O interface 109 is configured to receive the user attributes, current symptoms and medical reports of the user. The I/O Interface 109 also receives the details of the service provider for predicting consultation duration of the user. The I/O Interface 109 is also configured to receive from the database 105, a pre-defined disease of the current symptoms and pre-defined consultation duration for the current symptoms.

The received information from the I/O interface 109 is stored in the memory 111. The memory 111 is communicatively coupled to the processor 113 of the prediction system 101. The processor 113 causes the prediction system 101 to receive at least one of user attributes, current symptoms and medical records of the user. The processor 113 of the prediction system 101 determines the severity score based on the medical records. The processor 113 further determines a consultation preparation time based on the severity score and the user attributes. Further, the processor 113 of the prediction system 101 determines actual consultation time based on at least one of the current symptoms of the user, pre-defined disease of the current symptoms, pre-defined consultation duration for the current symptoms and details of service provider. The processor 113 further causes the prediction system 101 to predict the consultation duration based on the consultation preparation time and the actual preparation time for the user.

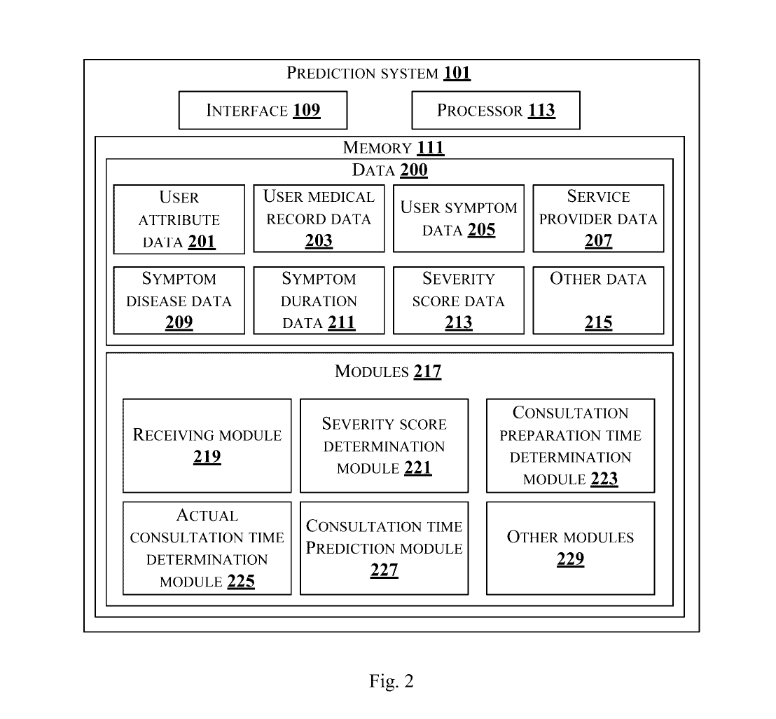

FIG. 2 shows a detailed block diagram illustrating a prediction system in accordance with some embodiments of the present disclosure.

In the illustrated FIG. 2, the one or more data 200 and the one or more modules 217 stored in the memory 111 are described herein in detail. In an embodiment, the data 200 includes user attribute data 201, user medical record data 203, user symptom data 205, service provider data 207, symptom disease data 209, symptom duration data 211, severity score data 213 and other data 215 for predicting consultation duration for a user.

The user attribute data 201 comprises details of the user which includes age, gender, educational level, marital status, location of the user etc. A person skilled in the art would understand that any other information related to user can be included in the user attribute data 201. The user attributes are received by the prediction system 101 from the appointment scheduling system 103. In an embodiment, the user attributes are provided by the user at the time of taking an appointment. Alternatively, the user attributes may be received from the database 105. In one embodiment the user attributes for each user is stored in the database 105 during registration of the user.

The user medical record data 203 comprises the medical history of the user. The medical record is received by the prediction system 101 for determining a severity score of the user. The medical record data 203 includes various symptoms, diseases and corresponding medical test and surgeries performed for those symptoms. The medical record data 203 also includes the family medical history of the users.

The user symptom data 205 comprises the current symptoms of the user. In an embodiment, the user symptom data 205 includes the evidence, indications or problems faced by the user. The current symptom data 205 is used for predicting the consultation duration required for the current medical condition of the user.

The service provider data 207 comprises details about the service provider. The details may include, but is not limited to, name, experience, specialty, identification number of the service provider. The service provider data 207 also includes the average time taken by each service provider for consulting symptoms similar to the symptoms of the user. The service provider data 207 is used for determining the average consultation time taken by a particular service provider. In one embodiment the service provider is a doctor.

The symptom disease data 209 comprises mapping of a number of possible symptoms with the associated diseases. The symptom disease data 209 identifies the disease associated with the current symptoms of the user.

The symptom duration data 211 comprises details about the duration required for consulting a particular symptom. The symptom duration data 211 is a pre-defined mapping of the symptoms with the required duration for consulting the symptom.

In an embodiment, the symptom disease data 209 and the symptom duration data 211 can also be present as a single entity and referred as symptom disease duration data. The symptoms disease duration data contains pre-defined mapping of the current symptoms with the associated diseases and the duration required for consulting those symptoms. Below Table 1 provides a non-limiting exemplary representation of the symptom disease duration data.

TABLE 1

| Symptoms | Disease | Consultation Duration |
|---|---|---|
| Yellow skin, dark urine, | Jaundice | 25 minutes |
| vomiting | | |
| Abdominal swelling and | Appendicitis | 35 minutes |
| pain, vomiting, loss of | | |
| appetite | | |
| High fever, severe headache, | Dengue Fever | 25 minutes |
| body rashes, pain behind | | |
| eyes, mild bleeding from | | |
| nose or gums | | |

The severity score data 213 comprises a numerical value which is derived from medical records of the user. The severity score data 213 is used for determining the consultation preparation time of the user.

The other data 215 may store data, including temporary data and temporary files, generated by modules for performing the various functions of the prediction system 101.

In an embodiment, the one or more data 200 in the memory 111 are processed by the one or more modules 217 of the prediction system 101. The one or more modules 217 may be stored within the memory 111 as shown in FIG. 2. In an example, the one or more modules 217, communicatively coupled to the processor 113, may also be present outside the memory 111 and implemented as hardware. As used herein, the term module refers to an application specific integrated circuit (ASIC), an electronic circuit, a processor 113 (shared, dedicated, or group) and memory that execute one or more software or firmware programs, a combinational logic circuit, and/or other suitable components that provide the described functionality.

In one implementation, the one or more modules 217 may include, for example, a receiving module 219, a severity score determination module 221, a consultation preparation time determination module 223, an actual consultation time determination module 225, and consultation time prediction module 227. The memory 111 may also comprise other modules 229 to perform various miscellaneous functionalities of the prediction system 101. It will be appreciated that such aforementioned modules may be represented as a single module or a combination of different modules.

The receiving module 219 receives the user attributes, current symptoms and medical records of the user. The receiving module 219 also receives information about the service provider. The receiving module 219 also receives information about the pre-defined symptom disease and the pre-defined symptom duration for the current symptoms.

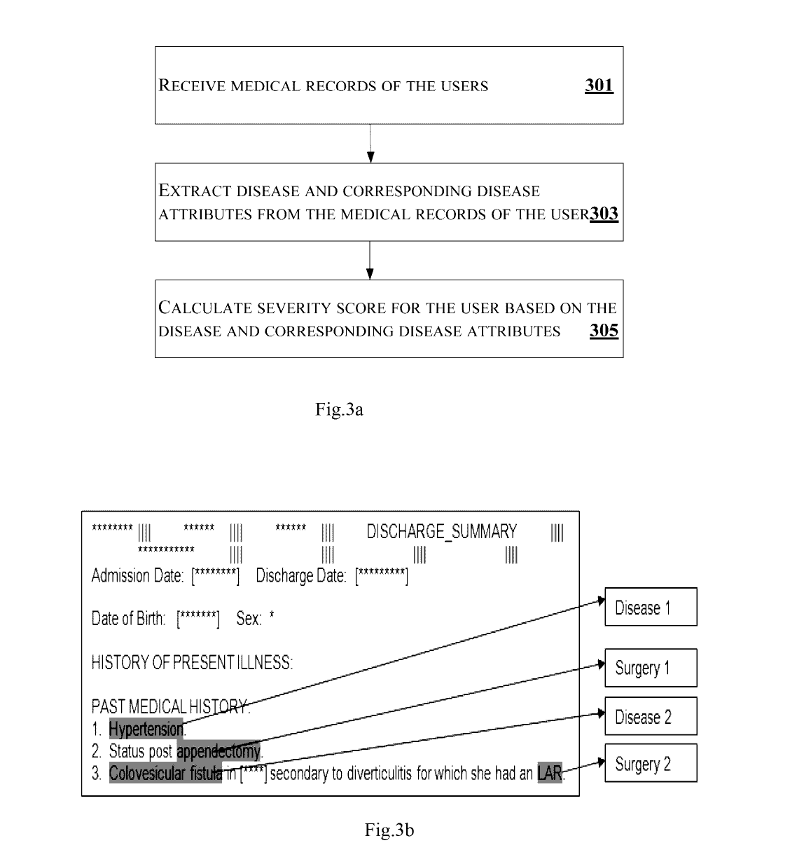

The severity score determination module 221 is configured to determine the severity score for a user. The severity score is a numerical value which is derived by the severity score determination module 221 based on the medical records of the user. The severity score is used for calculating the consultation preparation time. The severity score determination module 221 determines the severity score based on the diseases and corresponding diseases attributes of the user. FIG. 3a illustrates a flowchart showing a method for calculating severity score for a user in accordance with some embodiments of present disclosure.

As illustrated in FIG. 3a, the method comprises one or more blocks for calculating the severity score for a user. In an embodiment, when a user takes an appointment for a healthcare system, the user provides the medical records for the reference. Alternatively, the medical records are retrieved from the database 105. If the number of medical record is huge, the service provider has to go through complete records for understanding the medical condition. The time required for analysing each record depends on the type of information in the record. For example, if the record of a user contains some surgery done or some medical tests, the consultation preparation time may increase. Similarly, if the medical record contains less information, the consultation preparation time for the user would be less.

At block 301, medical records of the user are received by the prediction system 101.

At block 303, diseases and the corresponding diseases attributes are extracted from the medical records of the user by the prediction system 101. The disease attributes includes, for example surgery, medical test, etc.

At block 305, the severity score for the user is calculated based on the disease and the corresponding disease attributes by the prediction system 101. In an embodiment, the severity score is calculated by assigning a predefined score for each disease and corresponding disease attributes and aggregating the score for each disease and corresponding disease attributes. FIG. 3b shows an exemplary representation for identifying a severity score in accordance with some embodiments of present disclosure.

As shown in FIG. 3b, the sample document contains a discharge summary record for a user. The sample document comprises admission date and discharge data for the user. The sample document contains user attributes like date of birth, gender etc. The sample document contains the medical records of the user. The medical records are used for calculating the severity score of the user. For example, as shown in FIG. 3b, the medical record for a particular user contains two diseases namely ‘hypertension’ and ‘colovesicular fistula’. The corresponding attributes or the surgery for the diseases are ‘appendectomy’ and ‘lower anterior resection’ (LAR) respectively.

Apart from the medical records, the sample document may also contain social history and other medical conditions of the user. Based on the diseases and the corresponding disease attributes (surgery/tests), the severity score of the medical record for a user is calculated. The table below shows the calculation of severity score for the sample document.

TABLE 2

| Disease/Disease Attribute | Score |
|---|---|
| Hypertension(disease) | 1 |
| Appendectomy(surgery) | 1 |
| Colovesicular fistula(disease) | 1 |
| LAR(surgery) | 1 |

The severity score is the aggregate of all severity score of the medical records of the user. Based on the Table 1, severity score for the sample document is calculated as 1+1+1+1=4.

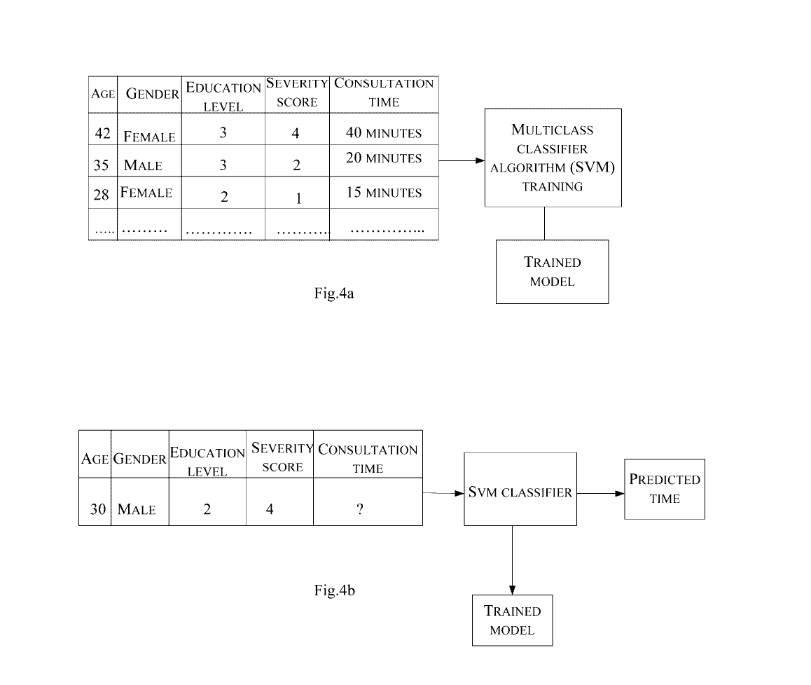

Referring back to FIG. 2, the consultation preparation time determination module 223 determines the consultation preparation time required by the service provider for a user. In an embodiment, the consultation preparation time is the time required by the service provider for understanding the medical condition of the user. The consultation preparation time determination module 223 determines the consultation preparation time from the user attributes and the severity score calculated for a user. The consultation preparation time determination module 223 also determines a trained model which is used for predicting the consultation preparation time for a user. FIG. 4a shows a method for generating a training model used in determining consultation preparation time in accordance with some embodiments of present disclosure.

As shown in FIG. 4a, previous records of plurality of users are received from the database 105. The previous record of the plurality of user contains user attributes, severity score and the consultation time for the users. Further the previous records of plurality of user are received by a multiclass classifier algorithm (SVM). The SVM are associated with learning algorithms which analyse the available data and categorize them. The SVM classifier, based on the previous records of the plurality of users generates a trained model, which is used for determining the consultation preparation time of a user. In an embodiment, classifiers other than the multiclass support vector machine (SVM) can also be used for generating a trained model.

FIG. 4b shows a method for predicting the consultation preparation time for a user using the trained model;

As shown in FIG. 4b, the user attributes and severity score for a particular user are received from the prediction system 101. Based on the user attributes and the severity score, the consultation preparation time for the user is determined. The user attributes and severity score of the user are further received by the SVM classifier. In an embodiment, the classifier other than the SVM classifiers can also be selected. The method further uses the trained model developed from the SVM classifier for determining the consultation preparation time for the user. Thus by using the trained model the consultation preparation time for a user is determined.

The actual consultation time determination module 225 determines the actual consultation time for a user. In an embodiment, the actual consultation time is the time required for consulting the current symptoms of the user by a particular service provider. The actual consultation time determination module 225 determines the average time of the service provider by using current symptoms and details of the service provider as input. The actual consultation time determination module 225 also determines the time required for consulting the medical condition of the user based on the current symptoms.

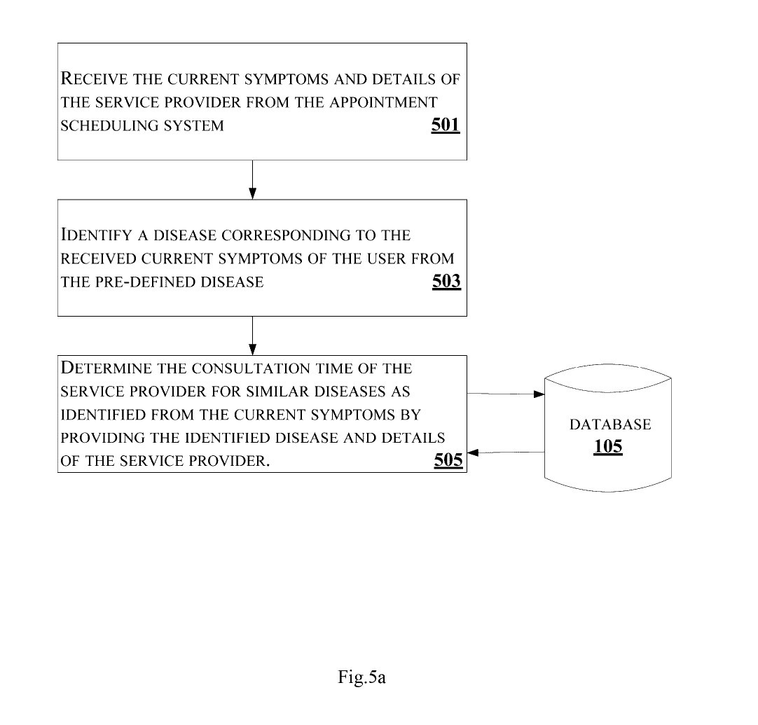

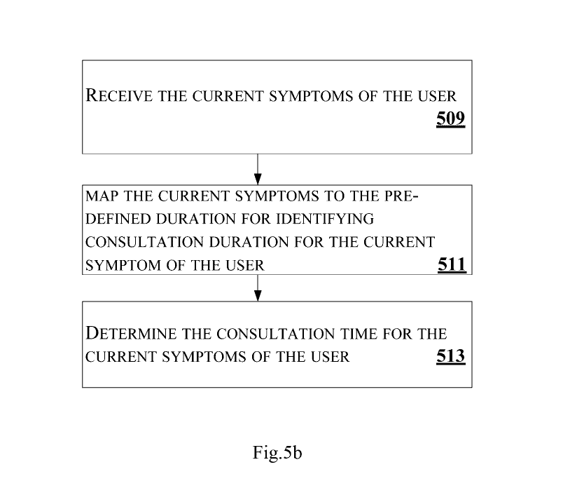

FIG. 5a illustrates a flowchart showing a method for determining average consultation time of the service provider in accordance with some embodiment of the present disclosure.

The average consultation time is the consultation time taken by the service provider for consulting users with similar symptoms. The average consultation time is used for predicting the consultation duration for a user.

At block 501, receive, by the prediction system 101, current symptoms and details of the service provider from the appointment scheduling system.

At block 503, identify, by the prediction system 101, one or more diseases corresponding to the received current symptoms from the pre-defined diseases of the current symptoms present in the database 105.

At block 505, determine, by the prediction system 101, the average consultation time of the service provider, for consulting similar diseases as identified from the current symptoms of the user, from the database 105. The prediction system 101 obtains the average consultation time of the service provider from the database 105, by providing the identified diseases and details of the service provider to the database 105. The database 105 further retrieves the average consultation time of the service provider for similar diseases to the prediction system 101.

FIG. 5b illustrates a flowchart showing a method for determining the consultation time for the current symptoms in accordance with some embodiments of the present disclosure.

At block 509 receive, by the consultation time prediction module 227 the current symptoms of the user.

At block 511, map, by the consultation time prediction module 227, current symptoms of the user with the pre-defined duration.

At block 513, determine, by the consultation time prediction system 227, the consultation time for the current symptoms of the user.

The consultation time prediction module 227 predicts the time required for consulting the medical condition of the user based on the current symptoms. The consultation time prediction module 227 predicts the duration for consultation based on the consultation preparation time and the actual consultation time of the user.

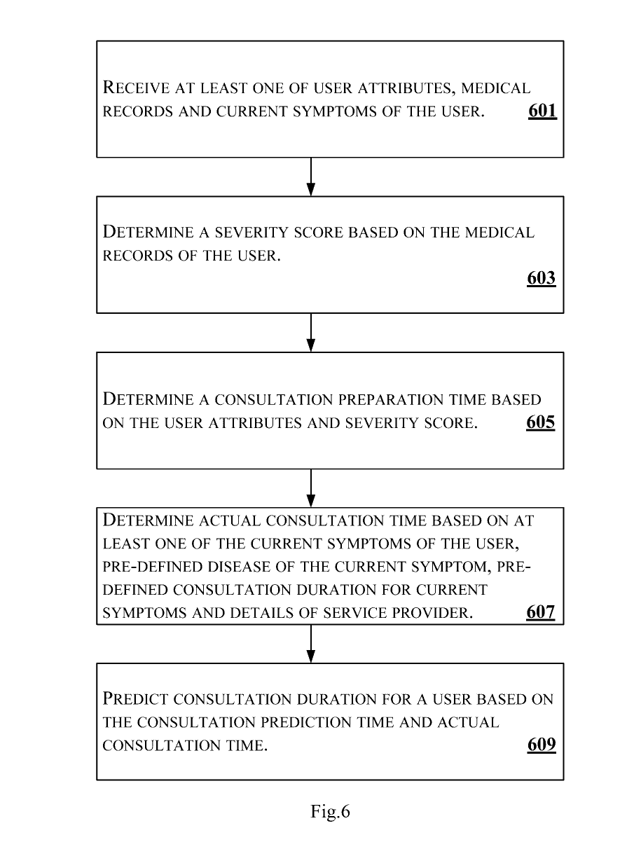

FIG. 6 illustrates an exemplary flowchart showing the method for predicting the consultation duration for a user in accordance with some embodiments of present disclosure.

As illustrated in FIG. 6, the method 600 comprises one or more blocks for predicting consultation duration for a user in a healthcare system. The method 600 may be described in the general context of computer executable instructions. Generally, computer executable instructions can include routines, programs, objects, components, data structures, procedures, modules, and functions, which perform particular functions or implement particular abstract data types.

The order in which the method 600 is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof.

The appointment scheduling system 103 appoints a user for consultation in the healthcare centres. The appointment scheduling system 103 further connects with the prediction system 101 for predicting the consultation duration for a user.

At block 601, receive, by the prediction system 101, at least one of user attributes, medical records and current symptoms of the user.

At block 603, determine, by the prediction system 101, a severity score based on the medical records of the user.

At block 605, determine, by the prediction system 101, a consultation preparation time based on the user attributes and severity score of the user.

At block 607, determine, by the prediction system 101, actual consultation time for the user based on at least one of the current symptoms of the user, pre-defined diseases of the current symptoms, pre-defined consultation duration for current symptoms and details of the service provider.

At block 609, predict, by the prediction system 101, the consultation duration for a user based on the consultation preparation time and the actual consultation time of the user.

### Computing System

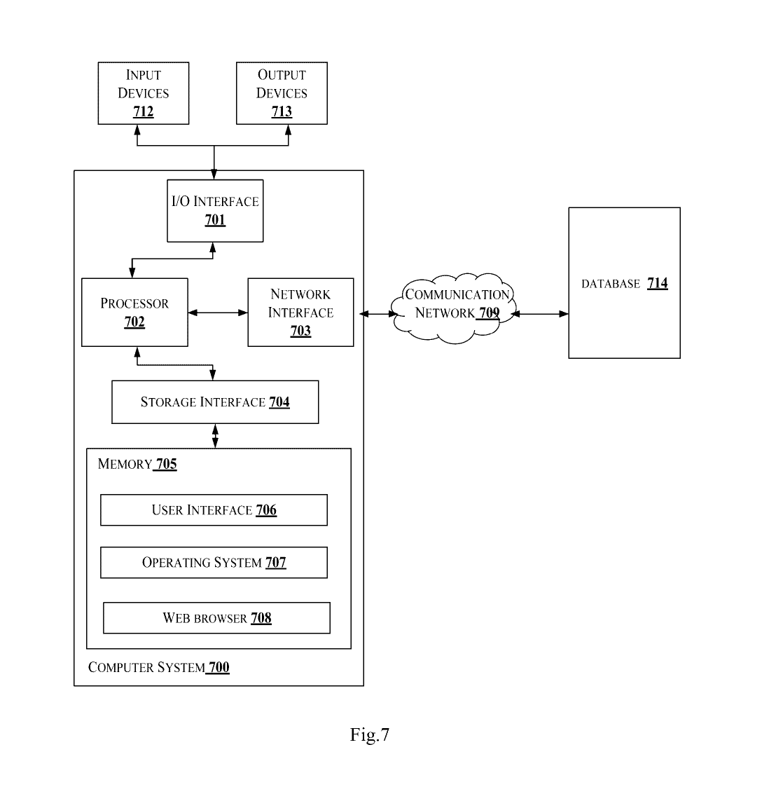

FIG. 7 illustrates a block diagram of an exemplary computer system 700 for implementing embodiments consistent with the present disclosure. In an embodiment, the computer system 700 is used to implement the prediction system. The computer system 700 may comprise a central processing unit (“CPU” or “processor”) 702. The processor 702 may comprise at least one data processor for predicting consultation duration for a user. The processor 702 may include specialized processing units such as integrated system (bus) controllers, memory management control units, floating point units, graphics processing units, digital signal processing units, etc.

The processor 702 may be disposed in communication with one or more input/output (I/O) devices (not shown) via I/O interface 701. The I/O interface 701 may employ communication protocols/methods such as, without limitation, audio, analog, digital, monaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 701, the computer system 700 may communicate with one or more I/O devices. For example, the input device may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output device may be a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, etc.

In some embodiments, the computer system 700 consists of a prediction system. The processor 702 may be disposed in communication with the communication network 709 via a network interface 703. The network interface 703 may communicate with the communication network 709. The network interface 703 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 709 may include, without limitation, a direct interconnection, local area network (LAN), wide area network (WAN), wireless network (e.g., using Wireless Application Protocol), the Internet, etc. Using the network interface 703 and the communication network 709, the computer system 700 may communicate with the database 714. The network interface 703 may employ connection protocols include, but not limited to, direct connect, Ethernet (e.g., twisted pair 10/100/1000 Base T), transmission control protocol/internet protocol (TCP/IP), token ring, IEEE 802.11a/b/a/n/x, etc.

The communication network 709 includes, but is not limited to, a direct interconnection, an e-commerce network, a peer to peer (P2P) network, local area network (LAN), wide area network (WAN), wireless network (e.g., using Wireless Application Protocol), the Internet, Wi-Fi and such. The first network and the second network may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the first network and the second network may include a variety of network devices, including routers, bridges, servers, computing devices, storage devices, etc.

In some embodiments, the processor 702 may be disposed in communication with a memory 705 (e.g., RAM, ROM, etc. not shown in FIG. 7) via a storage interface 704. The storage interface 704 may connect to memory 705 including, without limitation, memory drives, removable disc drives, etc., employing connection protocols such as serial advanced technology attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 705 may store a collection of program or database components, including, without limitation, user interface 706, an operating system 707, web server 708 etc. In some embodiments, computer system 700 may store user/application data 706, such as the data, variables, records, etc. as described in this disclosure. Such databases may be implemented as fault-tolerant, relational, scalable, secure databases such as Oracle or Sybase.

The operating system 707 may facilitate resource management and operation of the computer system 700. Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like.

In some embodiments, the computer system 700 may implement a web browser 708 stored program component. The web browser 708 may be a hypertext viewing application, such as Microsoft Internet Explorer, Google Chrome, Mozilla Firefox, Apple Safari, etc. Secure web browsing may be provided using Secure Hypertext Transport Protocol (HTTPS), Secure Sockets Layer (SSL), Transport Layer Security (TLS), etc. Web browsers 708 may utilize facilities such as AJAX, DHTML, Adobe Flash, JavaScript, Java, Application Programming Interfaces (APIs), etc. In some embodiments, the computer system 700 may implement a mail server stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as Internet Message Access Protocol (IMAP), Messaging Application Programming Interface (MAPI), Microsoft Exchange, Post Office Protocol (POP), Simple Mail Transfer Protocol (SMTP), or the like. In some embodiments, the computer system 700 may implement a mail client stored program component. The mail client may be a mail viewing application, such as Apple Mail, Microsoft Entourage, Microsoft Outlook, Mozilla Thunderbird, etc.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include Random Access Memory (RAM), Read-Only Memory (ROM), volatile memory, non-volatile memory, hard drives, CD ROMs, DVDs, flash drives, disks, and any other known physical storage media.

### Advantages of the Embodiment of the Present Disclosure are Illustrated Herein

An embodiment of the present disclosure predicts the consultation duration for a user in a healthcare system.

The present disclosure helps in reducing the consultation wait time for users in healthcare systems.

In one embodiment, the prediction system predicts the consultation duration for a user and help in enhancing user satisfaction

The described operations may be implemented as a method, system or article of manufacture using standard programming and/or engineering techniques to produce software, firmware, hardware, or any combination thereof. The described operations may be implemented as code maintained in a “non-transitory computer readable medium”, where a processor may read and execute the code from the computer readable medium. The processor is at least one of a microprocessor and a processor capable of processing and executing the queries. A non-transitory computer readable medium may comprise media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. Further, non-transitory computer-readable media comprise all computer-readable media except for a transitory. The code implementing the described operations may further be implemented in hardware logic (e.g., an integrated circuit chip, Programmable Gate Array (PGA), Application Specific Integrated Circuit (ASIC), etc.).

Still further, the code implementing the described operations may be implemented in “transmission signals”, where transmission signals may propagate through space or through a transmission media, such as an optical fiber, copper wire, etc. The transmission signals in which the code or logic is encoded may further comprise a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a non-transitory computer readable medium at the receiving and transmitting stations or devices. An “article of manufacture” comprises non-transitory computer readable medium, hardware logic, and/or transmission signals in which code may be implemented. A device in which the code implementing the described embodiments of operations is encoded may comprise a computer readable medium or hardware logic. Of course, those skilled in the art will recognize that many modifications may be made to this configuration without departing from the scope of the invention, and that the article of manufacture may comprise suitable information bearing medium known in the art.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “an” and “the” mean “one or more”, unless expressly specified otherwise.

A description of an embodiment with several components in communication with each other does not imply that all such components are required. On the contrary a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated operations of FIG. 6 show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

Referral Numerals

| Reference | |
|---|---|
| Number | Description |
| 100 | Environment |
| 101 | Prediction system |
| 103 | Appointment scheduling system |
| 105 | Database |
| 107 | Communication network |
| 109 | I/O interface |
| 111 | Memory |
| 113 | Processor |
| 200 | Data |
| 201 | User attribute data |
| 203 | User medical record data |
| 205 | User symptom data |
| 207 | Service providers data |
| 209 | Symptom disease data |
| 211 | Symptom duration data |
| 213 | Severity score data |
| 215 | Other data |
| 217 | Modules |
| 219 | Receiving module |
| 221 | Severity score determination module |
| 223 | Consultation preparation time determination module |
| 225 | Actual consultation time determination module |
| 227 | Consultation time prediction module |
| 229 | Other modules |

We claim:

1. A method for predicting consultation duration for a user in a healthcare system, the method comprising:
receiving, by a prediction module, at least one of user attributes, medical records of the user, and current symptoms of the user;
determining, by the prediction module, a severity score based on the medical records of the user;
determining, by the prediction module, consultation preparation time based on the user attributes and the severity score;
determining, by the prediction module, actual consultation time based on at least one of the current symptoms of the user, pre-defined disease of the current symptoms, pre-defined consultation duration for the current symptoms and details of service provider; and
predicting, by the prediction module, the consultation duration for the user based on the consultation preparation time and the actual consultation time.

2. The method as claimed in claim 1, wherein the user attributes comprise at least one of age, gender, education level, marital status and location of the user.

3. The method as claimed in claim 1, wherein determining the severity score comprises:
identifying, by the prediction module, diseases and corresponding disease attributes from the medical records of the user; and
determining, by the prediction module, the severity score based on the diseases and the corresponding disease attributes.

4. The method as claimed in claim 1, wherein determining the consultation preparation time of the user comprises providing the user attributes and the severity score to a trained model.

5. The method as claimed in claim 3, wherein the trained model is generated from the user attributes, the severity score and consultation time of previous records of plurality of users.

6. The method as claimed in claim 1, wherein determining the actual consultation time comprises:
identifying the average consultation time of a service provider based on the current symptoms of the user, the pre-defined disease of the current symptoms and the details of the service provider; and
determining consultation time of the medical condition based on the current symptoms of the user and the pre-defined consultation duration for the current symptoms.

7. A prediction module for predicting consultation duration for a user in a healthcare system, comprising:
a processor; and
a memory communicatively coupled to the processor, wherein the memory stores processor instructions, which, on execution, causes the processor to:
receive at least one of user attributes, medical records of the user, and current symptoms of the user;
determine a severity score based on the medical records of the user;
determine consultation preparation time based on the user attributes and the severity score;
determine actual consultation time based on at least one of the current symptoms of the user, pre-defined disease of the current symptoms, pre-defined consultation duration for the current symptoms and details of service provider; and
predict the consultation duration for the user based on the consultation preparation time and the actual consultation time.

8. The prediction module as claimed in claim 7, wherein the user attributes comprise at least one of age, gender, education level, marital status and location of the user.

9. The prediction module as claimed in claim 7, wherein the processor determines the severity score by performing:
identifying diseases and corresponding disease attributes from the medical records of the user; and
determining the severity score based on the diseases and the corresponding disease attributes.

10. The prediction module as claimed in claim 7, wherein the processor determines the consultation preparation time of the user by providing the user attributes and the severity score to a trained model.

11. The prediction module as claimed in claim 9, wherein the processor generates the trained model from the user attributes, the severity score and consultation time of previous records of plurality of users.

12. The prediction module as claimed in claim 7, wherein the processor determines the actual consultation time by performing:
identifying the average consultation time of a service provider based on the current symptoms of the user, the pre-defined disease of the current symptoms and the details of the service provider; and
determining consultation time of the medical condition based on the current symptoms of the user and the pre-defined consultation duration for the current symptoms.
